(19) United States
(12) Patent Application Publication
(10) Pub. No.: US 2014/0014266 A1
(43) Pub. Date: Jan. 16, 2014

(54) NARROW SURFACE COATING DEVICE AND METHOD FOR APPLYING A HEAT-ACTIVATABLE EDGE COATING BY MEANS OF HOT AIR OR HOT GAS

(71) Applicant: Christof Schulte-Goebel, Schmallenberg (DE)

(72) Inventor: Christof Schulte-Goebel, Schmallenberg (DE)

(21) Appl. No.: 14/008,059

(22) PCT Filed: Mar. 31, 2012
(86) PCT No.: PCT/DE2012/000360

§ 371 Date: Sep. 27, 2013

(30) Foreign Application Priority Data
Apr. 1, 2011 (DE) 10 2011 015 898.7

(51) Int. Cl. B29C 63/00

(52) U.S. Cl. CPC B29C 63/0026
USPC 156/309.9; 156/497

(57) ABSTRACT

The invention relates to an edge coating apparatus (1) for application of a strip-shaped edge strip (4) to narrow surfaces (6) of a work piece (5), wherein the edge strip (4) can be attached to the narrow surfaces (6), particularly in multiple layers, without adhesive or with a hot-melt glue layer between edge strip (4) and narrow surface (6), in heat-activatable manner, having at least a feed device (7) for the edge strip (4) and a press-down device (9) that presses the heat-activated edge strip (4) against the narrow surface (6) of the work piece (5). In this edge coating apparatus (1) and the corresponding coating method, an outlet (10) for hot air (16) is disposed in the region of feed device (7) and/or press-down device (9), which outlet applies the hot air (16), under pressure of one bar or more, to the edge strip (4) and/or the heat-activatable layer of the edge strip (4) and/or the narrow surface (6) of the work piece (5), wherein a heating device (3) standing in a fluid connection with the outlet (10), for the hot air (16), is provided, which device brings the hot air (16) to the required activation temperature for the heat-activatable layer of the edge strip (4) or the hot-melt glue.

The present invention relates to a narrow-surface coating apparatus for application of a heat-activatable, strip-shaped edge strip, particularly one in multiple layers, without adhesive or with an adhesive layer between edge strip and narrow surface, to narrow surfaces of a work piece, as well as to a corresponding method for application of such an edge coating.

Apparatuses for application of an edge strip to a narrow surface of a work piece, particularly a wood work piece, are known in different embodiments. These apparatuses, called edge gluing apparatuses, are used in woodworking to apply edge strips (also called edge banding) to a narrow surface of a work piece. Frequently, mechanically driven special machines are used for this purpose, which machines are predominantly suitable for applying edge strips to narrow surfaces of work pieces. These special machines are relatively expensive, but yield good results with regard to fit precision of the edge strip on the narrow surfaces of the work piece.

In this connection, edge strips that are provided with an activatable hot-melt glue on one side or do not yet have an adhesive applied to them are generally used. The edge strip is cut with an excess length, in accordance with the narrow-surface length of the work piece to be worked on, set onto the narrow surface of the work piece, fixed in place on the narrow surface after an adhesive that is viscous when heat is applied is applied to the edge or to the narrow surface of the work piece, or activation of a hot-melt glue that was previously applied, and, if necessary, is finished manually or by machine. This method, however, frequently yields only insufficient results with regard to the fit precision of the edge strip. Therefore, aside from the complicated handling of hot-melt glues (e.g. EVA or PUR) when applying them or pressing down, it is particularly disadvantageous, in the case of thermally activatable hot-melt glues that are applied in advance, as a layer, that the hot-melt glue layer remains visible after being applied, because of its required layer thickness and its partial hardening on the finished work piece, which is disadvantageous for esthetics. Also, temperature control of the hot-melt glue layer is difficult, because on the one hand, the highest possible coating temperature, which is responsible for temperature resistance and durability, is supposed to be reached, also in order to be able to reliably process the hot-melt glue even at higher advancing speeds of the edge strip, and on the other hand, the material of the edge strip, which frequently consists of plastic materials, is not allowed to be impaired by this. Also, cooling effects of the hot-melt glue occur as the result of the time between heating of the hot-melt glue layer and actually pressing down the edge strip, for example due to different heat dissipation into the work piece, which is generally cold, as the result of which the hot-melt glue frequently is not present in the optimal temperature range during gluing, and is therefore either too viscous or too thin, therefore causing gluing of the edge strip not to take place optimally, i.e. the adhesive layer to remain visible.

As a result of these problems, other materials for edge strips have been developed, which are able to prevent these disadvantages. Thus, for example, what are called adhesive-free edge strips have become known from EP 1 163 864 B1 and from EP 1 852 242 B1, which consists of two preferably co-extruded layers of different plastic materials, one of which is melted, under the influence of laser light, in such a manner that it can be applied to narrow surfaces in the same manner as in the case of the known hot-melt glue layers, and is glued to these narrow surfaces. In addition to the co-extruded edges, there are also other edge variants. These are post-co-extruded, for example, or subsequently provided with a coating (e.g. with polyolefin). In an ideal case, the different coatings have the same or a similar color as the edge strip itself. The other one of the two layers is not changed by the laser light and forms the visible outside of the edge strip. In this connection, these two co-extruded, post-co-extruded or subsequently coated layers are configured to look optically the same or similar, and particularly also have the same or a similar color, so that the melted layer, which is only thin, in any case, does not differ optically or differs only slightly from the remainder of the edge strip after the edge strip is applied. In the industry, one therefore speaks either of what is called a zero join, or, with reference to the usual manner of thermal activation, of a laser edge.

However, it is a disadvantage of this manner of coating of narrow surfaces on furniture panels or the like that this manner of coating requires a high level of apparatus expenditure. Thus, comprehensive laser systems, e.g. lasers with an output of 2 kW and more, are required for heating of the laser edges, and furthermore, worker protection is problematical due to the use of high-energy lasers, and there are problems with heating the edge strips, which are dependent on the shape of the edge strip. It is therefore known from EP 1 800 813 A2 or from DE 20 2009 009 253 U1 to use gases in plasma form for thermal activation of the edge strip in place of a laser beam; their production and handling are supposed to be easier than laser activation. However, even in this connection, a not insignificant apparatus expenditure is necessary, so that this technical solution, just like laser activation of the edge strips, is not suitable for a small workshop or even a do-it-yourselfer.

It is the task of the invention to make available an inexpensive and flexible manner of coating narrow surfaces of work pieces, particularly with multi-layer, heat-activatable edge strips that are adhesive-free or have an adhesive layer between edge strip and narrow surface, which manner can be performed simply, in terms of apparatus, and furthermore guarantees great fit precision and optical quality of the edge strip on the narrow surface of the work piece.

The solution of the task according to the invention is evident, with regard to the apparatus, from the characterizing features of claim 1, and, with regard to the method, from the characterizing features of claim 18, in interaction with the characteristics of the related preamble, in each instance. Further advantageous embodiments of the invention are evident from the dependent claims.

The invention with regard to the apparatus proceeds from a narrow-surface coating apparatus for application of a strip-shaped edge strip to narrow surfaces of a work piece, wherein the edge strip can be attached, with multiple layers, free of adhesive or with a hot-melt glue layer between edge strip and narrow surface, in heat-activatable manner, to the narrow surfaces (called zero join or laser edge), having at least a feed device for the edge strip and a press-down device, which presses the edge strip against the narrow surface of the work pieces. In the case of such an edge coating apparatus, an outlet for hot air or for hot gas is disposed, in a manner according to the invention, in the region of feed device and/or press-down device, which outlet applies the hot air or the hot gas to the edge strip and/or the heat-activatable layer of the edge strip, under pressure, whereby a heating device that stands in a fluid connection with the outlet, for the hot air or the hot gas, is provided, which device brings the hot air or the hot gas at least to the required activation temperature for the heat-activatable layer of the edge strip or of the hot-melt glue. Pressure that is applied, using the hot air or the hot gas, to the edge strip and/or to the heat-activatable layer of the edge strip, is understood, in this connection, to be a pressure of the hot air or of the hot gas that is higher then the pressure that can be guaranteed with known hot-air blowers.

It has surprisingly been shown that edge strips in the form of the zero join or laser edge, which usually consist of two-layer, mostly co-extruded or post-co-extruded materials or materials subsequently coated with polyolefins, for example, can also be heat-activated with hot air or hot gas, in such a manner that they can be securely glued to the narrow surfaces of the work piece. This is surprising, in that such edge strips are specifically not thermally heated in conventional manner, but rather have heat applied to them in very metered manner, by means of laser or plasma, which brings about a heat-activated zone that is small and not very thick, in which the edge strip must then be directly glued to the narrow surface of the work piece. Heating of the heat-activatable layer of the edge strip over a larger area, for example by means of hot air or hot gas, as is fundamentally known for the conventional adhesive-coated edge strips, furthermore also does not lead to the desired, result of local melting of the heat-activatable layer of the edge strip. If such heating of the edge strip is carried out with commercially available hot-air blowers used for this purpose, or the like, then the pressure given off by such blowers, and, in part, the volume stream of the hot air or the hot gas is not sufficient for heat activation, at a corresponding advance of the adhesive-free edge strip in question here. The heat-activatable layer of the edge strip is not melted or insufficiently melted, in this connection, so that gluing of the edge strip to the narrow surface of the work piece cannot take place or cannot reliably take place, at a corresponding, economically feasible advance. If, on the other hand, the temperature of the hot air or of the hot gas, as well as the volume stream of the hot air or of the hot gas, is clearly increased, and if the hot air or the hot gas therefore impacts the edge strip or its heat-activatable layer at a correspondingly high pressure, which is greater than the pressure that can be guaranteed with known hot-air blowers, then surprisingly, heat activation of the edge strip that is comparable to laser activation or plasma activation is achieved, which allows processing of the edge strip in the same manner as with the activation methods originally provided. In this connection, production of a corresponding volume stream of the hot air or of the hot gas, under higher pressure that is higher than the pressure that can be guaranteed with known hot-air blowers, which pressure impacts the edge strip or its heat-activatable layer as intended, is possible with significantly less technical effort than in the case of laser activation or plasma activation, and is therefore significantly more cost-advantageous. Furthermore, the edge coating apparatus according to the invention allows processing of corresponding edge strips not only on smaller edge coating apparatuses, such as a small workshop or also a do-it-yourselfer might use, but also, retrofitting of existing conventional edge coating apparatuses for processing of corresponding edge strips of the zero-joint or laser-edge type is possible. Also, use in industrial coating machines works without any problems. As a result, the ability to use edge strips in the form of zero joins is made accessible not only to use in small workshops but also to the industry. In this connection, it is particularly important that the hot air or the hot gas is applied to the edge strip or to the heat-activatable layer as close as possible before the first press-down roller and as close as possible to the edge strip or the heat-activatable layer, because otherwise, a clear drop in pressure and temperature of the hot air or of the hot gas as compared with the pressure and the temperature directly at the outlet of the nozzle, and furthermore, an admixture of cold ambient air is found, which makes the required heating of the edge strip or of the heat-activatable layer difficult or impossible. If this is taken into consideration, then advancing speeds during coating of narrow sides of work pieces can be achieved that lie in the range of 1-20 m/min or more, and therefore also allow efficient coating. This apparatus is also suitable for use in processing centers for processing of molded parts, because of its construction size.

However, it has also been shown that application of the hot air or of the hot gas, according to the invention, can improve the use of edge strips in which a heat-activatable hot-melt glue is disposed between narrow surface of the work piece and edge strip, for example previously has been or is applied to the edge strip or the narrow surface of the work piece. In this connection, normally the hot-melt glue is applied to the narrow surface of the work piece (or, in rare cases, to the edge strip), for example by means of a film-like application by an application apparatus. On the path between the actual pressing down of an application zone for the hot-melt glue that precedes the edge strip and the press-down location of the edge strip, the hot-melt glue already cools again slightly, for example by means of the dissipation of heat into the significantly cooler work piece. The hot-melt glue therefore generally no longer has the optimal viscosity at the time of press-down of the edge strip, so that the glue connection of the hot-melt glue, which is already solidifying, can result in reduced adhesion values and glue edges that remain visible after gluing. If, now, in a manner according to the invention, during the entire time period between application of the hot-melt glue and pressing down the edge strip or shortly ahead of the first press-down roller, hot air or hot gas is applied to the edge strip or to the narrow surface of the work piece or to the hot-melt glue, in the manner described, then the edge strip remains warm, and therefore the hot-melt glue also remains liquid, as required, and can penetrate even further into the frequently porous carrier material of the work piece, and anchor there. Also, due to the viscosity of the hot-melt glue, which remains high because of the heating that is still taking place, the layer thickness of the hot-melt glue between edge strip and narrow surface of the work piece becomes very slight, so that a configuration of the join with a conventional hot-melt glue between edge strip and narrow surface can be achieved, which comes very close to what is called the zero join of laser or plasma activation. Furthermore, because of the thin join of the hot-melt glue and its deep penetration into the work piece panel, not only its good cross-linking with the narrow surface but also the durability of the glue connection is improved. It is advantageous, in this connection, if the hot air or the hot gas is directed in such a manner, in the section between hot-melt glue application and pressing down of the edge strip, that in this section the edge strip or the narrow surface of the work piece and thereby the applied adhesive remain under temperature control. This can be done, for example, by means of orientation of the stream of the hot air or of the hot gas parallel or perpendicular or at another angle relative to the longitudinal expanse of the edge strip or of the narrow surface of the work piece.

It is particularly advantageous if the outlet for the hot air or the hot gas is configured in the form of a nozzle having a narrow outlet slot or multiple small nozzle openings, which outlet blows the hot air or the hot gas onto the edge strip and/or the heat-activatable layer of the edge strip or the narrow surface of the work piece uniformly over the entire width of the edge strip or the narrow surface of the work piece. Such a nozzle allows very targeted application of the hot air or of the hot gas produced onto the edge strip or its heat-activatable layer or the narrow surface of the work piece, whereby uniform heating conditions of the heat-activatable layer of the edge strip or the narrow surface of the work piece can be achieved over the entire width of the edge strip or the narrow surface of the work piece. Furthermore, such a nozzle additionally accelerates the volume stream of the exiting hot air or of the hot gas, so that the exit velocity and therefore also the impact velocity of the hot air or of the hot gas onto the edge strip or its heat-activatable layer or the narrow surface of the work piece and thereby the impact pressure can be greatly increased as compared with edge coating of conventional hot-air production. In this way, the edge strip and the narrow surface of the work piece are strongly heated at certain points or in line shape, for a short time, and the heat-activatable layer is reliably melted, so that it can be pressed well and firmly against the narrow surfaces of the work piece, and fastened in place there. At the same time, because of the only short-term and strong heating of the edge strip in the region of effect of the outlet for the hot air or the hot gas, the non-heat-activatable layer of the edge strip is not impermissibly heated, above all not with optically visible effects, and thereby retains its desired technical and optical properties. In a further embodiment, it is possible that the outlet for hot air or hot gas is disposed and oriented in such a manner that the hot air or the hot gas escapes in the direction of the work piece and/or the press-down zone for the edge strip on the narrow surface. In this way, the edge strip can be temperature-controlled over a longer section, directly by the press-down location of the edge strip, and either the heat-activatable layer of the edge strip or the separately applied hot-melt glue can be optimally adjusted for production of the glue connection.

In another embodiment, it is also possible that the outlet for the hot air or the hot gas is configured as an arrangement of multiple nozzles or adjustable nozzles, which arrangement blows the hot air or the hot gas onto the edge strip and/or the heat-activatable layer of the edge strip and/or the narrow surface of the work piece over the entire width of the edge strip and/or the narrow surface of the work piece or parts thereof. Here, different arrangements of the individual nozzles can be used, by means of which the hot air or the hot gas is applied, for example, when using edge strips having different widths, only in the region of the edge strip to be processed, in each instance, and/or the narrow surface of the work piece, and individual lateral nozzles are shut off, by means of which the edge strip would not be heated at all. This contributes to a reduction in the required amount of the hot air or of the hot gas in the case of narrower edge strips. It is possible, for example, that the nozzle has a narrow outlet slot or a number of outlet bores disposed adjacent to one another.

It is significantly advantageous if the hot air or the hot gas impacts the edge strip and/or the heat-activatable layer of the edge strip at an elevated pressure that is higher than the pressure that can be guaranteed with known hot-air blowers, as compared with atmospheric pressure. This elevated pressure, which usually results primarily from a large conveyed volume stream of the hot air or of the hot gas, in combination with the advancing speed, contributes to particularly effective heating of the heat-activatable layer of the edge strip and/or of the narrow surface of the work piece, so that the heat-activatable layer can be melted at temperatures that avoid impairment of the other layer of the edge strip. In this connection, the hot air or the hot gas can impact the edge strip and/or the heat-activatable layer of the edge strip under a pressure of more than one bar, preferably of more than two bar, as compared with atmospheric pressure.

The elevated pressure of the hot air or hot gas blown onto the edge strip can advantageously be achieved in that the supplied air is already blown into the heating device under pressure, preferably of more than two bar as compared with atmospheric pressure. In this way, for one thing, unavoidable flow losses on the path through the heating device are compensated, and for another, turbulent flow through the heating device is produced, which allows particularly good heat transfer to the hot air or the hot gas to be produced. As a result, the air blown into the heating device under elevated pressure is particularly suitable for bringing about heat activation of the edge strip. The air or gas blown into the heating device can be derived, for example, tram an external compressed air generator or the like. Alternatively or also additionally, an air-conveying device, preferably a ventilator, can be disposed in or on the heating device.

Specifically for use of the edge coating apparatus in the small workshop sector, but also in the industrial sector and for mobile coating apparatuses, it is advantageous if the heating device is disposed in space-saving manner, particularly below or above or to the side or in front of or behind the feed device and the press-down device. As a result, the heating device is situated in the vicinity of the outlet for the hot air or the hot gas, thereby making is possible to prevent or greatly reduce cooling of the hot air or of the hot gas on the path from the heating device to the outlet. At the same time, this arrangement of the heating device does not, however, hinder the handling of work piece and edge strip in the region of the edge coating apparatus, and the machine operator can work on the edge coating apparatus as usual, without being spatially hindered by the heating device. In the case of stationary or even larger mobile coating apparatuses, the heating device can, of course, also be disposed at a different location, for example to the side outside of the work region, if the fluid connection between heating device and outlet and a corresponding heat insulation of this connection are guaranteed, so that the hot air or the hot gas does not cool too much on the way to the nozzle.

In an advantageous embodiment, it is possible that the heating device has a gas or air guide that runs preferably in meander shape or circular shape from the outside to the inside or vice versa, in the form of heat exchanger elements through which flow takes place one after the other, in which the air drawn in from the surroundings or blown in under pressure, for example at two bar or more, is brought into contact with heating elements, directly or indirectly, which heat this air or gas to produce hot air or hot gas. Such heat exchanger elements can be formed, for example, by pipe bundles that lie parallel to one another, in sections, which are disposed adjacent to at least one heating element, in each instance, or another pipe, and which pass the heat energy of the heating element on to the air that flows through the pipe bundles. Also possible are air-permeable sintered plates with heating elements. Such heating devices can be put together, in cost-advantageous manner and on the basis of conventional modules, and thereby produced in cost-advantageous manner. Of course, it is also possible that different types of heat exchangers or heating elements are used; for example, heating elements heated electrically or with gas can be used. Also, the air guide within the heating device can be structured other than in meander shape; a more circular arrangement of the air guide, for example, in circular shape from the outside to the inside or vice versa, is also possible, simply as an example. When using an arrangement of the air guide structured in meander shape, it is possible that overflow regions are disposed between the pipe bundles, which are preferably parallel to one another in certain sections, in which regions the heated hot air or the hot gas overflows into the subsequent pipe bundle of the subsequent heat exchanger, in the flow direction.

It is advantageous, particularly with regard to the effectiveness of the heat transfer to the hot air or the hot gas, if the heating device is configured in heat-insulated manner with regard to the surroundings. In this way, the heating device can be heated more or less in reserve during times when no hot air or no hot gas is needed, so that when hot air is called for, a corresponding amount of heat is available, which also allows a coating process of the edge coating apparatus that lasts a longer time, without disruptions in the supply of hot air or hot gas. In the heating device, a required amount of heat is more or less stored in reserve, and then allows very rapid calling for this heat when coating the narrow surfaces of a work piece, which can be used over an extended period of time. For this purpose, the heating device can actually be overheated during times when no hot air or no hot gas is needed, and then additionally serves more or less as a heat storage unit, from which even large amounts of hot air or hot gas can be called up at a high volume stream. Also from the aspect of worker protection, it is advantageous if the heating device is protected by means of insulation, for example in the form of insulation materials such as rock wool, glass wool, or the like, so that no open hot surfaces of the heating device are present, which could lead to burns incurred by the operating personnel.

The invention furthermore relates to a method for application of a strip-shaped edge strip to narrow surfaces of a work piece, whereby the edge strip is attached to the narrow surfaces, particularly in multiple layers, without adhesive or with a hot-melt glue layer between edge strip and narrow surface, in heat-activatable manner, by means of a feed device for the edge strip and a press-down device that presses the heat-activated edge strip against the narrow surface of the work piece. In this method, hot air or hot gas is applied to the edge strip and/or the heat-activatable layer of the edge strip in the region of feed device and/or press-down device, under pressure, whereby the hot air or the hot gas is brought, by a heating device, at least to the required activation temperature for the heat-activatable layer of the edge strip or of the hot-melt glue. In this connection, the hot air or the hot gas can particularly also be blown onto the edge strip and/or the heat-activatable layer of the edge strip at elevated pressure as compared with atmospheric pressure. Thus, the hot air or the hot gas can advantageously impact the edge strip and/or the heat-activatable layer of the edge strip under a pressure of more than one bar, preferably of more than two bar as compared with atmospheric pressure.

Furthermore, it is possible that the effect of the hot air or of the hot gas when impacting the edge strip and/or the heat-activatable layer of the edge strip is regulated by means of influencing the volume stream and/or the temperature and/or the pressure of the hot air or of the hot gas and/or the advancing speed of the edge strip during coating of the narrow surface. By means of influencing the variables of volume stream and/or temperature and/or pressure of the hot air or of the hot gas, as well as the advancing speed of the edge strip during coating, and their interaction during the coating process, a desired degree of heat activation of the heat-activatable layer of the edge strip can be achieved by means of melting of the heat-activatable layer, which degree allows an optimal glue connection of the edge strip with the narrow surface of the work piece, for example as a function of the bendability of the edge strip, its material, and the properties of the heat-activatable layer.

A particularly preferred embodiment of the edge coating apparatus according to the invention is shown in the drawing.

This shows:

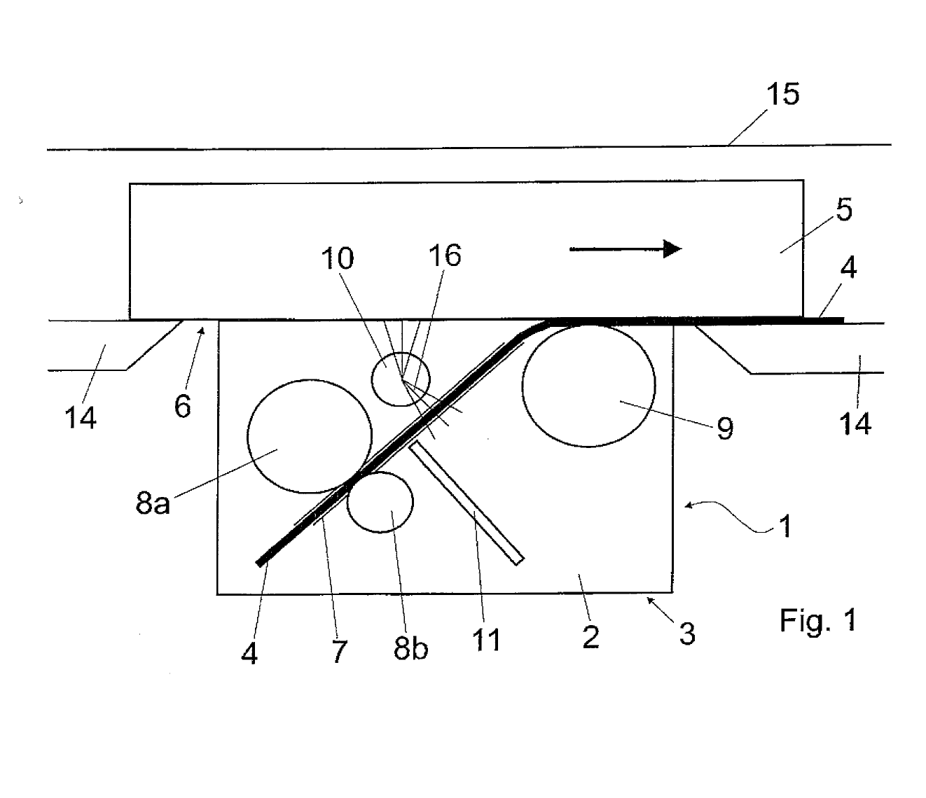

FIG. 1—a schematic top view of an edge coating apparatus according to the invention,

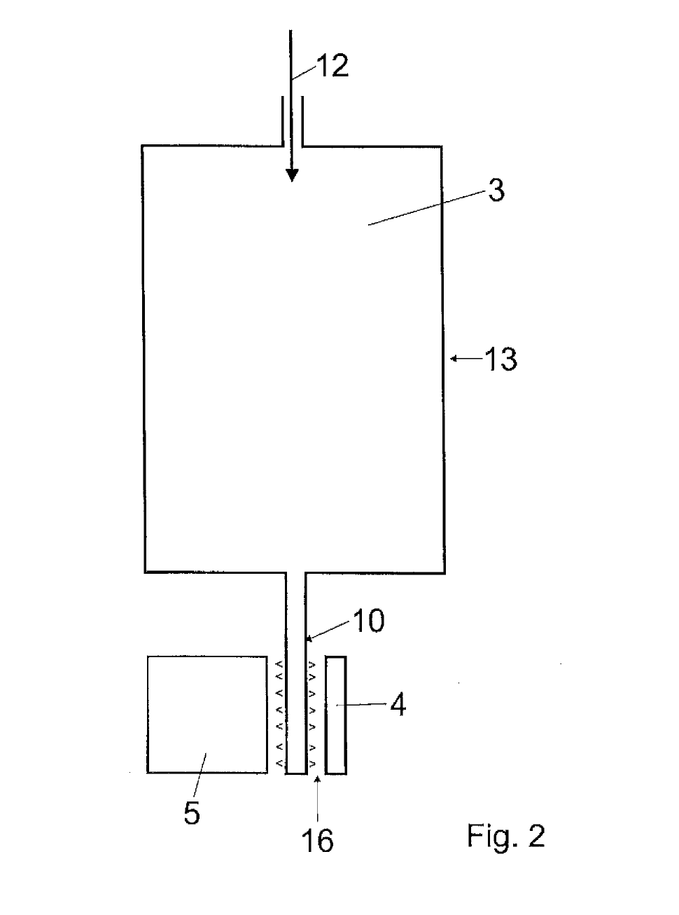

FIG. 2—schematically represented interaction of the essential components of the edge coating apparatus between heating device and edge strip during coating of narrow surfaces of the work piece.

In FIG. 1, a schematic top view of an edge coating apparatus 1 for application of an edge strip 4 to a narrow surface 6 of a work piece 5 is shown according to a preferred embodiment of the present invention.

The edge coating apparatus 1 according to the invention has a support 2, which is configured essentially in plate shape in this exemplary embodiment. A feed device 7 for continuous feed of the edge strip 4, a first pressure roller 8b, an advancing roller 8a, a press-down roller 9, an outlet 10 for hot air 16 as well as a cutting device 11 are disposed on the support 2. The advancing roller 8a, the pressure roller 8b, and the press-down roller 9 are mounted so as to rotate, in each instance. The feed device 7 comprises a guide rail, not shown in detail here, along which the edge strip 4 is guided in the feed direction.

The feed device 7 is configured in such a manner that it feeds the edge strip 4 of the narrow surface 6 at an acute angle relative to the advancing direction of the work piece 5. The pressure roller 8b stands in an active connection with the edge strip 4 within the feed device 7, and ensures continuous feed of the strip in the transport direction, within the feed device 7. Furthermore, an additional advancing roller 8a is provided, which is disposed to lie opposite the pressure roller 8b, in such a manner that the feed device 7 runs between the pressure roller 8b and the advancing roller 8a in certain sections. The advancing roller 8a ensures secure guidance of the edge strip 4 in the feed device 7.

An outlet 10 for hot air 16 or the hot gas is disposed behind the guide roller 8a, in the advancing direction, in such a manner that the hot air 16 or the hot gas that flows out of the outlet 10 is essentially directed at the heat-activatable layer of the edge strip 4 and/or the narrow surface of the work piece. This heat-activatable layer is usually a thermoplastic, usually co-extruded, post-co-extruded or subsequently coated material or hot-melt glue, which is activated by means of supplying heat at a specific temperature, causing it to melt, so that the edge strip 4 can adhere to the narrow surface 6 of the work piece 5.

Furthermore, seen in the advancing direction, a press-down roller 9 is provided behind the outlet 10 for the hot air 16 or the hot gas, which roller is configured in such a manner that the edge strip 4 is bent, in the advancing direction, in such a manner that it is oriented essentially parallel to the narrow surface 6 of the work piece 5, with precise fit. During manual or mechanical advancing of the work piece 5, a force component always acts perpendicular to the advancing direction, in the direction of the edge coating apparatus 1. As a result, a press-down pressure is produced between the narrow surface 6 of the work piece 5, the edge strip 4, and the press-down roller 9, in order to produce an adhesion connection between the narrow surface 6 and the edge strip 4.

Finally, in the present exemplary embodiment, a manually activatable cutting device 11, which is articulated on so as to pivot about an axis of rotation, is also provided. In this connection, a cutting surface of the cutting device 11 is disposed in such a manner that when an activation lever of the cutting device 11 is activated, it cuts through the edge strip 4 approximately in a section between the advancing roller 8a and the outlet 10, transverse to the transport direction. Manual activation of the cutting device 11 therefore permits cutting the edge strip 4 with sufficiently accurate fit, so that the edge strip 4 ends essentially flush with the narrow surface 6 of the work piece 5.

Below the support 2, the heating device 3 is disposed in a manner not indicated in further detail, in such a manner that the path of the hot air 16 produced to the outlet 10 is short, and, at the same time, the heating device 3 does not hinder the operation and the use of the edge coating apparatus 1 any further. In this connection, the heating device 3 can be heat-insulated, in that the heating device 3 is completely packed in an insulation material such as glass wool, rock wool or the like.

In this connection, the outlet 10 of the edge coating apparatus 1 for the hot air 16 or the hot gas produced in the heating device 3 is advantageously configured as a slot nozzle, which forms a longitudinally shaped, narrow outlet for the hot air 16 or the hot gas. However, the nozzle can also consist of multiple small nozzle openings. This slot nozzle or nozzle arrangement of individual nozzles ensures uniform distribution of the hot air 16 or of the hot gas over the entire width of the edge strip 4, as well as additional acceleration of the hot air 16 or of the hot gas when it impacts on the edge strip 4.

In FIG. 2, a schematic representation of the interaction between heating device 3 and edge strip 4 during coating of narrow surfaces of the work piece 6 can be seen. Air 12 drawn in from the surroundings, for example by way of a fan, not shown, or the like, or fed into the heating device 3 from a compressed air source, also not shown, is brought into contact with heat, in the heating device 3, by way of heat exchanger elements, not shown in any detail, for example parallel pipe bundles or sintered material with an electrically operated or gas-operated heating element embedded in it, for example, and heated to approximately 400-700° C. After passing through the heating device 3, this hot air 16 or the hot gas exits through the slot-shaped outlet 10, in the direction of the edge strip 4 and/or the narrow surface of the work piece, and heats the heat-activatable layer of the edge strip 4 and/or the narrow surface of the work piece in the manner already described. By means of the fundamentally known method of effect of the edge coating apparatus 1, the edge strip 4 is pressed against the narrow surface 6 of the work piece 5, and when it cools, adheres to this narrow surface 6.

### REFERENCE NUMBER LIST

1 edge gluing apparatus
2 support
3 heating device
4 edge strip
5 work piece
6 narrow surface
7 feed device
8a-guide roller
8b-advancing roller
9 press-down roller
10 outlet
11 cutting device
12 air feed
13 heat feed
14 stop
15 work piece rest
16 hot air/hot gas

1. Edge coating apparatus (1) for application of a strip-shaped edge strip (4) to narrow surfaces (6) of a work piece (5), wherein the edge strip (4) can be attached, particularly in multiple layers, without adhesive or with a hot-melt glue layer between edge strip (4) and narrow surface (6), in heat-activatable manner, onto the narrow surfaces (6), having at least a feed device (7) for the edge strip (4) and a press-down device (9) that presses the edge strip (4) against the narrow surface (6) of the work piece (5),
wherein
an outlet (10) for hot air or hot gas (16) is disposed in the region of feed device (7) and/or press-down device (9), which outlet applies the hot air (16) or the hot gas, under pressure to the edge strip (4) and/or the heat-activatable layer of the edge strip (4) and/or the narrow surface (6) of the work piece (5), wherein a heating device (3) for the hot air (16) or the hot gas is provided, standing in a fluid connection with the outlet (10), which device brings the hot air (16) or the hot gas at least to the required activation temperature for the heat-activatable layer of the edge strip (4) or of the hot-melt glue.

2. Edge coating apparatus (1) according to claim 1, wherein the edge strip (4) is configured in multiple layers and heat-activatable without adhesive, as an at least two-layer co-extruded or post-co-extruded or subsequently coated edge strip (4).

3. Edge coating apparatus (1) according to claim 1, wherein the edge strip (4) is configured in one or multiple layers, and as an edge strip (4) that can be glued with a heat-activatable hot-melt glue.

4. Edge coating apparatus (1) according to claim 1, wherein the outlet (10) for the hot air (16) or the hot gas is configured in the form of a nozzle having a narrow outlet slot or multiple small nozzle openings, which outlet blows the hot air (16) or the hot gas uniformly onto the edge strip (4) and/or the heat-activatable layer of the edge strip (4) and/or the narrow surface of the work piece, over the entire width of the edge strip (4).

5. Edge coating apparatus (1) according to claim 4, wherein the outlet (10) for hot air or hot gas (16) is disposed and oriented in such a manner that the hot air or the hot gas (16) escapes in the direction of the narrow surface (6) of the work piece (5) and the press-down zone (9) for the edge strip (4) on the narrow surface (6).

6. Edge coating apparatus (1) according to claim 4, wherein the nozzle has a narrow outlet slot or a number of outlet bores disposed adjacent to one another.

7. Edge coating apparatus (1) according to claim 1, wherein the outlet (10) for the hot air (16) or the hot gas is configured as an arrangement of multiple nozzles or adjustable nozzles, preferably adjustable in width, which blows the hot air (16) or the hot gas onto the edge strip (4) and/or the heat-activatable layer of the edge strip (4) over the entire width of the edge strip (4).

8. Edge coating apparatus (1) according to claim 1, wherein the hot air (16) or the hot gas impacts the edge strip (4) and/or the heat-activatable layer of the edge strip (4) under elevated pressure as compared with atmospheric pressure.

9. Edge coating apparatus (1) according to claim 1, wherein the hot air (16) or the hot gas impacts the edge strip (4) and/or the heat-activatable layer of the edge strip (4) under a pressure of more than one bar, preferably of more than two bar, as compared with atmospheric pressure.

10. Edge coating apparatus (1) according to claim 1, wherein the supplied air (12) or the gas can be blown into the heating device (3) under pressure, preferably of more than two bar as compared with atmospheric pressure.

11. Edge coating apparatus (1) according to claim 1, wherein an air-conveying device, preferably a fan or a compressor or the like, is disposed in or on the heating device (3).

12. Edge coating apparatus (1) according to claim 1, wherein the heating device (3) is disposed in space-saving manner, preferably below or above or to the side of or in front of or behind the feed device (7) and the press-down device (9).

13. Edge coating apparatus (1) according to claim 1, wherein the heating device (3) has an air guide that preferably runs in meander shape or circular shape, from the outside to the inside or vice versa, in the form of heat exchanger elements through which flow takes place one after the other, in which the air (12) drawn in from the surroundings or blown in under pressure or the gas is brought into contact with heating elements (13), directly or indirectly, which heat the air to produce the hot air (16) or the hot gas.

14. Edge coating apparatus (1) according to claim 13, wherein the heat exchanger elements are formed by pipe bundles that are parallel to one another, in certain sections, or air-permeable sintered plates, which are disposed adjacent to at least one heating element (13) each, or to another pipe bundle or other sintered plates, and pass the heat energy of the heating element (13) on to the air (12) or the gas that flows through the pipe bundles or the sintered plates.

15. Edge coating apparatus (1) according to claim 14, wherein overflow regions are disposed between the pipe bundles that are preferably parallel to one another, in certain sections, in which regions the heated hot air (16) overflows into the subsequent pipe bundle of the subsequent heat exchanger, in the flow direction.

16. Edge coating apparatus (1) according to claim 1, wherein the heating device (3) is configured to be heat-insulated with regard to the surroundings.

17. Edge coating apparatus (1) according to claim 1, that wherein the heating elements (13) can be heated electrically or by means of fluid media, preferably by means of gas.

18. Method for application of a strip-shaped edge strip (4) to narrow surfaces (6) of a work piece (5), wherein the edge strip (4) is attached to the narrow surfaces (6), particularly in multiple layers, without adhesive or with a hot-melt glue layer between edge strip and narrow surface, in heat-activatable manner, by means of a feed device (7) for the edge strip (4) and a press-down device (9) that presses the heat-activated edge strip (4) against the narrow surface (6) of the work piece (5),
wherein
hot air (16) or hot gas is applied, under pressure, to the edge strip (4) and/or the heat-activatable layer of the edge strip (4), in the region of feed device (7) and/or press-down device (9), wherein the hot air (16) or the hot gas is brought at least to the required activation temperature for the heat-activatable layer of the edge strip (4) or of the hot-melt glue, by a heating device (3).

19. Method according to claim 18, wherein the heating device (3) is heated to such a temperature and heat amount that guarantees heating of the hot air (16) at least to the required activation temperature, even during longer coating procedures.

20. Method according to claim 18, wherein the hot air (16) or the hot gas is blown onto the edge strip (4) and/or the heat-activatable layer of the edge strip (4) under elevated pressure as compared with atmospheric pressure.

21. Method according to claim 18, wherein the hot air (16) or the hot gas impacts the edge strip (4) and/or the heat-activatable layer of the edge strip (4) under a pressure of more than one bar, preferably of more than two bar as compared with atmospheric pressure.

22. Method according to claim 18, wherein the supplied air (12) or the gas is blown into the heating device (3) under pressure, preferably of more than two bar as compared with atmospheric pressure.

23. Method according to claim 18, wherein the effect of the hot air (16) or of the hot gas when it impacts the edge strip (4) and/or the heat-activatable layer of the edge strip (4) is regulated by means of influencing the volume stream and/or the temperature and/or the pressure of the hot air (16) or of the hot gas and/or the advancing speed of the edge strip (4) during coating of the narrow surface (6).
